(19) United States
(12) Patent Application Publication
(10) Pub. No.: US 2016/0292392 A1
(43) Pub. Date: Oct. 6, 2016

(54) SYSTEM AND METHOD OF DETERMINING MISSING INTERVAL CHANGE INFORMATION IN RADIOLOGY REPORTS

(71) Applicant: KONINKLIJKE PHILIPS N.V., Eindhoven (NL)

(72) Inventors: YE XU, MILFORD, CT (US); YUECHEN QIAN, BRIARCLIFF MANOR, NY (US)

(73) Assignee: Koninklijke Philips N.V., Eindhoven (NL)

(21) Appl. No.: 15/035,805

(22) PCT Filed: Nov. 14, 2014
(86) PCT No.: PCT/IB2014/066040

§ 371 Date: May 11, 2016

Related U.S. Application Data
(60) Provisional application No. 61/908,782, filed on Nov. 26, 2013.

(51) Int. Cl. G06F 19/00; G06F 17/30

(52) U.S. Cl. CPC G06F 19/3487; G06F 17/30707; G06F 19/3443; G06F 19/327; G06F 19/3406

(57) ABSTRACT

A system, method and computer readable storage medium for analyzing a medical report to determine if interval change data corresponding to a change of the medical data over time is required, extracting keywords from a predetermined field in the medical report corresponding to an interval change, categorizing the extracted keywords into a first category corresponding to the interval change if the keywords conform to a first pattern and categorizing the extracted keywords into a second category if the keywords conform to a second pattern and generating a notification message if the keywords correspond to the second category.

Radiology procedures often require the communication of patient data between multiple medical professionals (e.g., referring physicians, oncologists, radiologists, etc.). In such cases, a radiology report is transmitted by a radiologist to another medical professional. The radiology report includes data pertinent to the patient and may include data corresponding to multiple visits. In such cases, it is vital for the receiving medical professional to have information regarding interval change of the patient between the multiple visits. However, radiologists often forget to enter the interval change data. In such cases, the medical professional is unable to diagnose a patient, thus requiring additional doctor visits, additional correspondence with medical staff to request the missing information and delay of a diagnosis or treatment of the patient.

A system, method and computer readable storage medium for analyzing a medical report to determine if interval change data corresponding to a change of the medical data over time is required, extracting keywords from a predetermined field in the medical report corresponding to an interval change, categorizing the extracted keywords into a first category corresponding to the interval change if the keywords conform to a first pattern and categorizing the extracted keywords into a second category if the keywords conform to a second pattern and generating a notification message if the keywords correspond to the second category.

Several embodiments of the invention will be described in the following by way of example and with reference to the accompanying drawings in which:

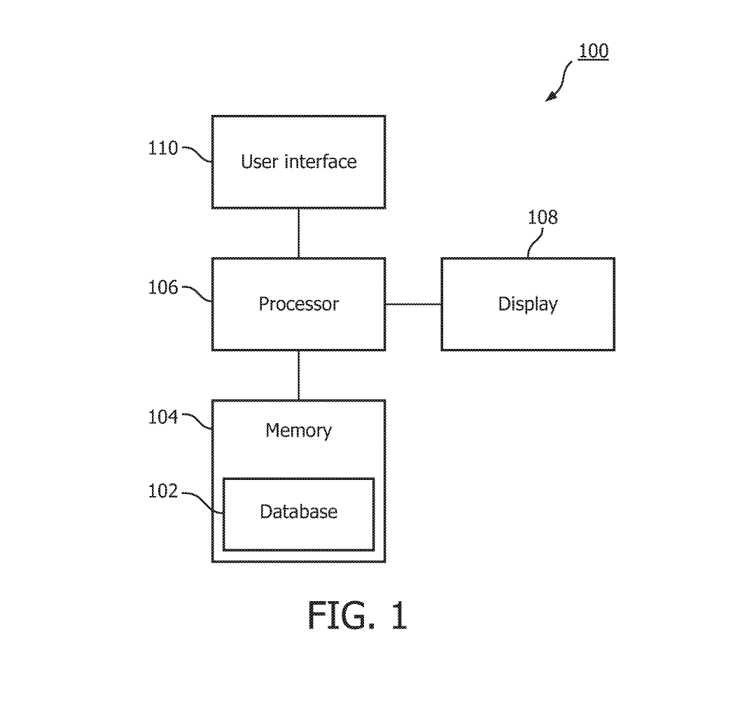

FIG. 1 depicts a schematic drawing of a system according to an exemplary embodiment;

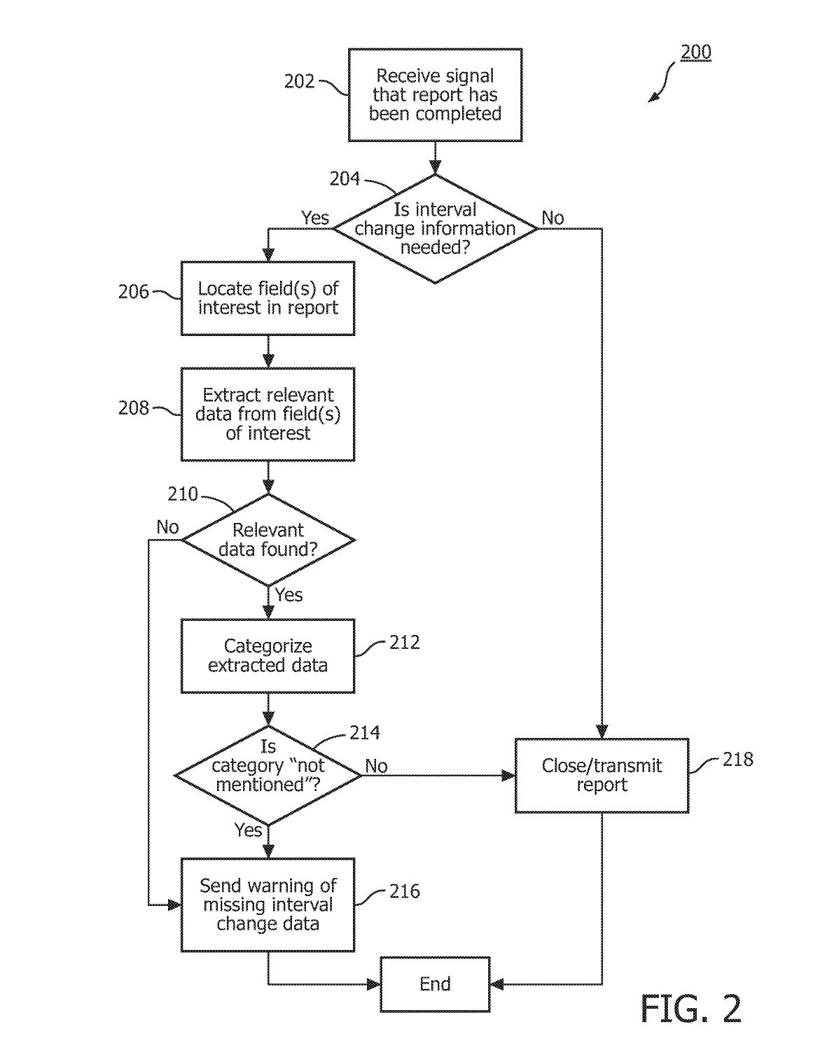

FIG. 2 depicts a flow diagram of an exemplary method;

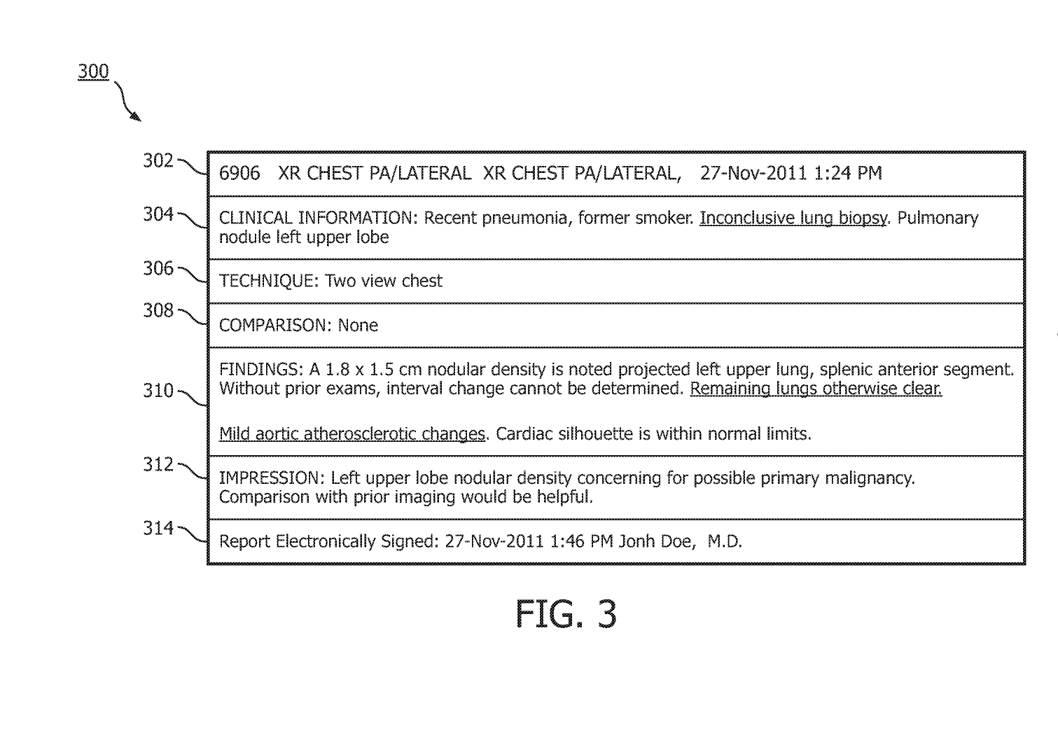

FIG. 3 depicts a radiology report according to a first exemplary embodiment;

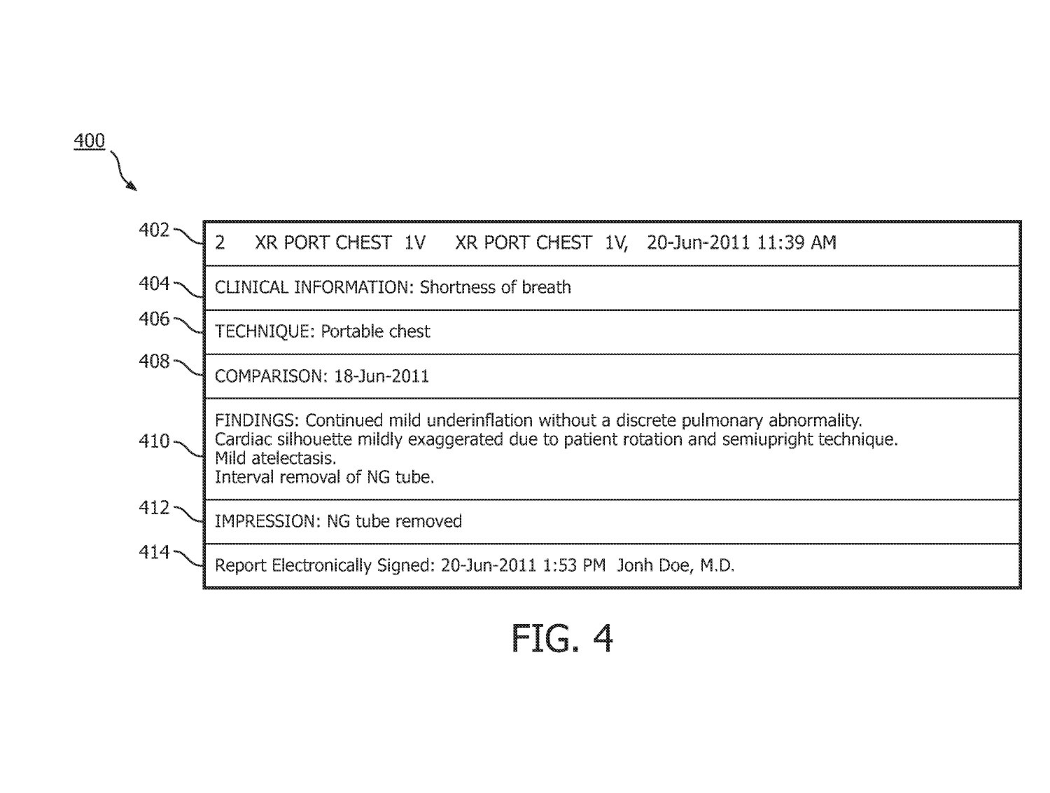

FIG. 4 depicts a radiology report according to a second exemplary embodiment; and

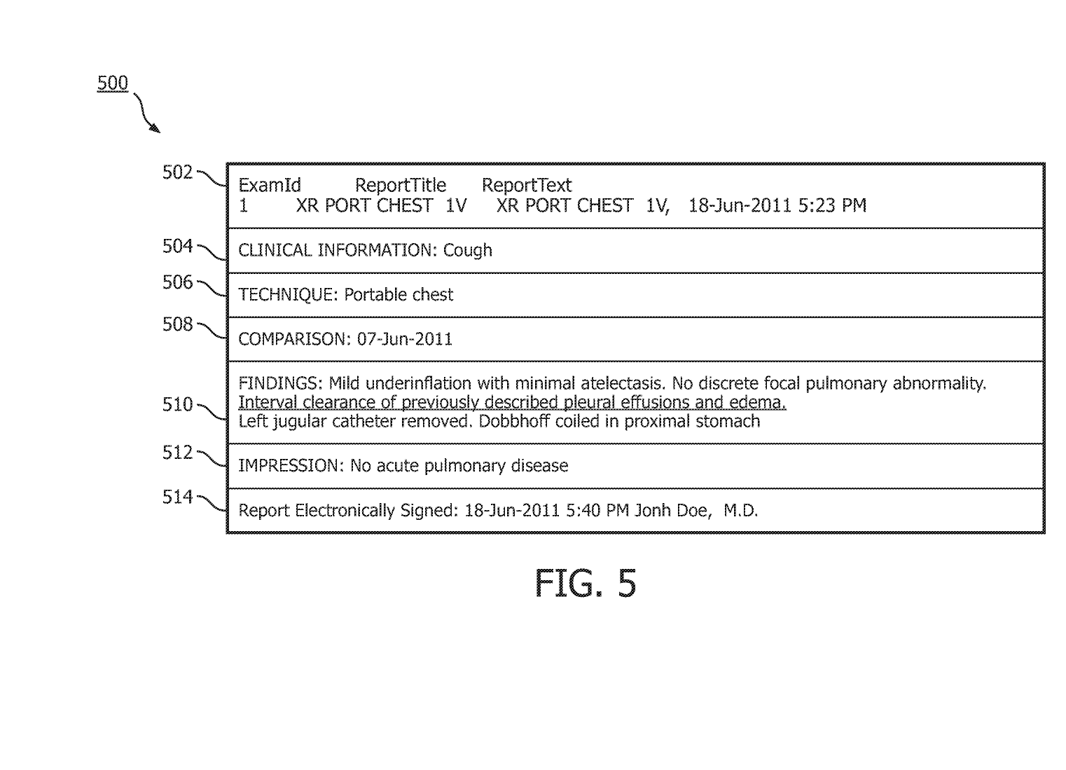

FIG. 5 depicts a radiology report according to a third exemplary embodiment.

The exemplary embodiments may be further understood with reference to the following description and appended drawings. The exemplary embodiments propose a system and method for generating a warning if vital fields have been omitted when creating and/or transmitting a radiology report. In a first exemplary embodiment, the system is linked to a standard picture archiving and communication system (“PACS”) known in the art. In an operative configuration, the system monitors the fields of a medical report created via the PACS system and generates a warning message if the radiologist attempts to close and/or transmit the radiology report without vital fields. Specifically, the exemplary method is initiated once the radiologist attempts to close and/or transmit the radiology report. The system determines from entries in the radiology report if interval change information is necessary. Exemplary interval change information includes a change in size, shape and location of a lesion, nodule or other feature of interest in a subject. Specifically, the system determines if the radiology report references any previous state of the subject or previous radiology report within the current report. If so, the system uses an exemplary algorithm to scan at least a part of the radiology report for a predetermined set of keywords and categorize the interval change based on the search results. If the keywords within the radiology report conform to one of a predetermined set of categories, the system permits the radiology report to be closed or transmitted. If the keywords within the radiology report do not conform to one of the predetermined set of categories, it is categorized as “not mentioned”. A warning message is then generated to alert the radiologist of the missing information and permit the omission to be entered. The exemplary algorithm disclosed herein may be used to remind radiologists or quality assurance personnel of missing interval change information in a radiology report. It is noted that although the exemplary system and method has been described with respect to radiology reports in a PACS, the exemplary search and classification algorithm disclosed herein may be applied to or in combination with any other information extraction algorithms in any other medical informatics report system.

An exemplary embodiment is described in greater detail with respect to FIGS. 1-2, which depict an exemplary system 100 and method 200. In a first exemplary step 202, the system 100 monitors the PACS and determines if a radiologist or other user has provided a notification that a radiology report is completed via a user interface 110 (e.g., keyboard, touch-screen, etc). This notification may be generated when the radiologist closes the radiology report in the PACS or if the radiologist attempts to transmit the radiology report over the PACS. The notification may be one of automatically generated by the PACS or may be manually generated by the user. Thus, before the PACS closes or before the radiology report is transmitted to an intended recipient(s), the method proceeds to step 204. In step 204, the system 100 determines if interval change information is needed in the radiology report. Specifically, a processor 106 of the system 100 scans data input into the memory 104 as well as data stored on a database 102 (e.g., previously entered data) and determines if patient information is available from a previous session. For example, the processor 106 may scan the radiology report to determine if the report includes data from multiple sessions. If so, the system 100 determines a time frame between the plurality of sessions. Specifically, the processor may reference from each of the plurality of radiology reports a field containing the date of entry and determine a time difference therebetween. If information is available for only a single session (e.g., the current session) or if the time frame between the multiple sessions is determined to be clinically insignificant, the method proceeds to step 218 wherein the radiology report is either closed or transmitted. If the system 100 locates data corresponding to a previous comparison study, the system determines that an interval change is needed and proceeds to step 206. In an alternate embodiment, the system 100 may select a time frame (e.g., less than one month, less than one week, etc.) which may be deemed clinically insignificant, thus foregoing the need for interval change information. Similarly, in another embodiment, if the time frame is greater than a predetermined threshold (e.g., greater than one month, greater than one week, etc.), the system 100 may determine that interval change information is necessary. In another embodiment, if the date of entry of the radiology report is not provided in the corresponding field, the processor 106 may scan the entirety of the radiology report to locate date information, wherein the date information corresponds to a predetermined pattern (e.g., DD/MM/YYYY, DD/MM/YY, etc.), as those skilled in the art will understand.

In step 206, the system 100 uses natural language processing NLP) to locate in the radiology report findings of interest which include detailed information about the anatomical, spatial and location characteristics of the part of the body being tested. For example, the system 100 may locate a paragraph or field in the radiology report containing the relevant data. In another embodiment, the system 100 may scan only one or more predetermined fields of the radiology report (e.g., “Findings” field, “Impression” field, etc.) for the relevant data. Once the field of interest has been identified in the radiology report, the method proceeds to step 208 wherein the system 100 extracts from the field of interest the specific information used to describe interval change. Specifically, the system 100 scans the data in the field of interest for a predetermined set of keywords, which have been selected based on the typical words or phrases used to describe interval change and stored in the database 102. Table 1 depicts a non-comprehensive list of such keywords. It is noted that the keywords in Table 1 are exemplary only and may include any other keywords used to describe interval change.

TABLE 1
Category Classes of Interval Change

| Category Name | Format | |
|---|---|---|
| Interval | 1. | “interval” + “resolution \| healing \| clearing |
| resolution | | \| clearance \| improvement” |
| | 2. | “[has been \| be \| is] + resolved” |
| Interval | 1. | “interval decrease” |
| decrease | 2. | “decrease ([ds in the]*) size” |
| | 3. | “volume loss” |
| | 4. | “decrease + Time” or Time at the front |
| No interval | 1. | “unchanged \| stable \| unremarkable” |
| change | 2. | Negation + “change \| increase \| decrease \| |
| | | recurrence \| variation \| progression” |
| Non- | 1. | Negation + Significant + “interval change”, |
| significant | | or Non-significant + “interval change”, or |
| interval | | “interval change + Non-significant” |
| change | 2. | Non-significant + “change + Time” or Time at |
| | | the front |
| | 3. | “change + Non-significant + Time” or Time at |
| | | the front |
| | 4. | “similar to” or “similar in size” or “within |
| | | normal limits” |
| | (“Significant” can be “substantial”, | |
| | “significant”, “gross”, “obvious”, “definite”, and | |
| | “appreciable”, etc. “Non-significant” could be | |
| | “little”, “limited”, “few”, “slight”, “minimal”, | |
| | “no obvious”, “minimal”, etc.) | |
| Interval | 1. | “Change \| worsened \| worsening \| increase |
| change | | \|decrease \| more \| less + Time” or Time at |
| | | the front |
| | 2. | “Interval” + “change \| progression \| |
| | | resolution \| development \| improvement”. |
| | 1. | “interval” + “increase \| grow” |
| | 2. | “Increase ([ds in the]*) size + Time” or Time |
| | | at the front |
| Interval | 3. | “grow \| increase + Time” or Time at the front |
| increase | | |
| Not | 1. | A pattern that does not match all other |
| mentioned | | interval change patterns. |

If the system 100 locates one or more of the keywords of Table 1 in the field of interest, the system moves to step 212 wherein the keywords are categorized. If no keywords are found, the system moves to step 216 wherein a warning message is generated to indicate that interval change information is missing from the report, as will be described in greater detail below. Returning to step 212, the system 100 scans the field(s) of interest for the keywords listed in the format′ category of Table 1. As those of skill in the art will understand, these keywords are descriptors for lesions and other anomalies typically analyzed via radiology and described in radiology reports, as will be described in greater detail below with respect to FIGS. 3-5. Once any number of the above keywords are located in the radiology report, the keywords are categorized into one of the seven categories listed in Table 1. Specifically, the system 100 determines to which of the categories the located keywords belong. Table 2 below depicts example findings that relate to each of the seven categories, as determined via a keyword search algorithm as defined in Table 1.

TABLE 2
Examples of Category Classes of Interval Change

| Category Name | Example |
|---|---|
| Interval | 1. Significant interval clearing of the diffuse |
| resolution | central lobular groundglass opacities |
| | identified on the prior exam. |
| | 2. 84 year old woman with a history of previous |
| | spontaneous left nipple discharge, which has |
| | subsequently resolved. |
| Interval | 1. Interval decrease in the amount of cortical |
| decrease | thinning as a result of less severe grade 4 |
| | hydronephrosis |
| | 2. Continues interval decrease in reference |
| | lumphadenopathy. |
| No interval | 1. This is no evident of interval change since |
| change | prior normal pre- and post-enhanced brain MRI |
| | from Jun. 24, 2011. |
| | 2. Bilateral deep brain stimulations without |
| | interval change in the position since prior |
| | study. |
| Non- | 1. Mild to moderate CHF without significant |
| significant | interval change. |
| interval | 2. This lesion measures approximately 1.8 × 1.2 |
| change | cm (image 18, series 1101), not significantly |
| | changed from the prior exam when it measured |
| | 1.8 × 1.2 cm. |
| Interval | 1. Interval change in the salience and |
| change | enhancement characteristics of these lesions. |
| | 2. Compared to prior exam there is apparent |
| | slight uniform thickening of the soft palate |
| | and minimally of the left oropharyngeal wall. |
| Interval | 1. Interval increase in mesenteric |
| increase | lymphadenopathy. |
| | 2. Interval increase groundglass opacities of |
| | worsening edema with moderate pleural |
| | effusions. |
| Not | 1. Coarse atherosclerotic calcifications |
| mentioned | involving the distal abdominal aorta. |
| | 2. Increasing right basilar opacity may |
| | represent atelectasis however, infection and |
| | infarction cannot be excluded. |

If, in step 212, the keywords include the terms “interval” and any of the terms “resolution”, “healing”, “clearing”, “clearance” and “improvement” or the term “resolved”, the system 100 classifies the radiology report in the category of “interval resolution”. If the report contains keywords that do not correspond to any other of the categories of Table 1, the data is categorized as “not mentioned”. In step 214, the system 100 determines if the category is “not mentioned”, in which case the method proceeds to step 216 to send a warning to the radiologist indicating that interval change data is missing. The warning 216 may be in the form of a window shown on a display 108, an audio notification, haptic feedback, a message (e.g., mobile, email, etc.) transmitted to the radiologist, or any combination of the above. In this event, it is recognized that the data included in the radiology report is not sufficient to permit an end user (e.g., physician) to properly categorize interval change information to diagnose/treat the patient. If the category is any of “interval resolution”, “interval decrease”, “no interval change”, “non-significant interval change”, “interval change” or “interval increase”, the method proceeds to step 218 wherein the radiology report is closed and/or transmitted as requested by the radiologist.

In another embodiment, the category selected from Table 1 may be included in the radiology report. In yet another embodiment, the system 100 can highlight text indicating the keywords relevant to interval change in the radiology report.

It is noted that the above keywords and categories are only exemplary. There may be other keywords and categories that are also relevant to radiology reports that may be scanned for in fields of interest and categorized. In fact, over time, the system 100 may learn different keywords that relate to interval information or a user may add keywords or categories for the keywords. In addition, those skilled in the art will understand that different types of reports (e.g., different types of radiology reports or non-radiology reports) may be analyzed using keywords and categories that are appropriate for the type of report.

FIG. 3 depicts an exemplary radiology report 300 including a plurality of fields 302, 304, 306, 308, 310, 312, 314 corresponding to title information, clinical information, technique, comparison, findings, impression and radiologist signature, respectively. In accordance with the exemplary method 200, the system 100 receives a notification that a report is to be completed and/or transmitted by the radiologist in step 202. In step 204, the system 100 examines the radiology report 300 to determine if interval change information is needed. In one embodiment, the system 100 may first analyze the comparison field 308. Generally, the comparison field 308 lists the date of any previous radiology report as well the date of the present radiology report. In the radiology report, the comparison field 308 recites “none”, indicating that no previous radiology report has been created for the present subject. However, as a verification step within step 204, the system 100 further analyzes the clinical information field 304. In the present embodiment, a scan of the clinical information field 304 produces keywords relating to anatomy and slice information (e.g., nodule, “left upper lobe”) thus indicating to the system that a nodule was found in a previous study and that interval change information is needed. The system 100 then proceeds to steps 206-214 and uses NLP technology to extract words, phrases or sentences containing any previous findings (e.g., from an earlier radiology report), as described in greater detail earlier. Using the keywords provided in Table 1, the system 100 determines that the radiology report 300 is classified under the category of “not mentioned”, thus prompting the display of a warning message to the radiologist of the missing interval change information.

FIG. 4 depicts another exemplary radiology report 400 including a plurality of fields 402, 404, 406, 408, 410, 412, 414 corresponding to title information, clinical information, technique, comparison, findings, impression and radiologist signature, respectively. In accordance with the exemplary method 200, the system 100 receives a notification that a report is to be completed and/or transmitted by the radiologist in step 202. In step 204, the system 100 examines the radiology report 400 to determine if interval change information is needed. In the present embodiment, the comparison field 408 recites a previous report date of Jun. 18, 2011, thus indicating that interval change information is needed. The system 100 then proceeds to steps 206-214 and uses NLP technology to extract words, phrases or sentences containing any previous findings (e.g., from the earlier radiology report), as described in greater detail earlier. Using the keywords provided in Table 1, the system 100 determines that the radiology report 400 is classified under the category of “not mentioned”, thus prompting the display of a warning message to the radiologist of the missing interval change information.

FIG. 5 depicts another exemplary radiology report 500 including a plurality of fields 502, 504, 506, 508, 510, 512, 514 corresponding to title information, clinical information, technique, comparison, findings, impression and radiologist signature, respectively. In accordance with the exemplary method 200, the system 100 receives a notification that a report is to be completed and/or transmitted by the radiologist in step 202. In step 204, the system 100 examines the radiology report 500 to determine if interval change information is needed. In the present embodiment, the comparison field 508 recites a previous report date of Jun. 7, 2011, thus indicating that interval change information is needed. The system 100 then proceeds to steps 206-214 and uses NLP technology to extract words, phrases or sentences containing any previous findings (e.g., from the earlier radiology report), as described in greater detail earlier. Using the keywords provided in Table 1, the system 100 determines that the radiology report 500 is classified under the category of “interval resolution”. Thus, upon categorization of the radiology report 500, the method 200 proceeds to step 218 wherein the report is transmitted/closed.

Those skilled in the art will understand that the above-described exemplary embodiments may be implemented in any number of manners, including, as a separate software module, as a combination of hardware and software, etc. For example, the system 100 may include a program containing lines of code that, when compiled, may be executed on a processor. The programs may be embodied on a non-transitory computer readable storage medium.

It is noted that the claims may include reference signs/numerals in accordance with PCT Rule 6.2(b). However, the present claims should not be considered to be limited to the exemplary embodiments corresponding to the reference signs/numerals.

It will be appreciated by those skilled in the art that various modifications and alterations of the invention can be made without departing from the broad scope of the appended claims. Some of these have been discussed above and others will be apparent to those skilled in the art.

1. A method, comprising:
analyzing a medical report to determine if interval change data corresponding to a change of the medical data over time is required;
extracting keywords from a predetermined field in the medical report corresponding to an interval change;
categorizing the extracted keywords into a first category corresponding to the interval change if the keywords conform to a first pattern and categorizing the extracted keywords into a second category if the keywords conform to a second pattern; and
generating a notification message if the keywords correspond to the second category.

2. The method of claim 1, further comprising the step of receiving a notification that a medical report has been completed, the notification automatically initiating the analyzing of the medical report.

3. The method of claim 1, wherein the first category is selected from a set including at least one of interval resolution, interval decrease, no interval change, non-significant interval change, interval change and interval increase.

4. The method of claim 3, wherein the keywords are selected from a predetermined list corresponding to the set.

5. The method of claim 1, wherein the analyzing of the medical report comprises scanning the medical report for keywords corresponding to one of anatomy and slice information from a previous session.

6. The method of claim 1, wherein the analyzing of the medical report comprises calculating a time interval between a previous medical report session and the medical report.

7. The method of claim 6, wherein if the time interval is above a predetermined threshold, a processor determines that interval change information is needed.

8. The method of claim 1, wherein the notification message is one of a window display, audio message and haptic feedback.

9. The method of claim 1, further comprising the step of receiving, via a user interface, the medical report.

10. The method of claim 1, wherein the medical report is a radiology report transmitted via a picture archiving and communication system.

11. A system for alerting a medical professional of missing information in a medical report, comprising:
a memory storing a keyword database including keywords corresponding to an interval change; and
a processor that executes instructions to perform operations, comprising analyzing the medical report to determine if interval change data corresponding to a change of the medical data over time is required, extracting keywords from a predetermined field in the medical report corresponding to the keywords in the keyword database, categorizing the extracted keywords into a first category corresponding to the interval change if the keywords conform to a first pattern and categorizing the extracted keywords into a second category if the extracted keywords conform to a second pattern and generating a notification message if the extracted keywords correspond to the second category.

12. (canceled)

13. (canceled)

14. The system of claim 11, wherein the processor automatically initiates the analysis of the medical report upon completion or attempted transmission thereof.

15. (canceled)

16. The system of claim 1, wherein the first category is selected from a set including at least one of interval resolution, interval decrease, no interval change, non-significant interval change, interval change and interval increase, wherein the keywords are selected from a predetermined list corresponding to the categories of the set.

17. (canceled)

18. (canceled)

19. The system of claim 11, wherein the processor uses neuro-linguistic programming to locate the keywords of the keyword database in the medical report.

20. A non-transitory computer-readable storage medium with an executable program stored thereon, wherein the program instructs a processor to perform the following operations:
analyzing a medical report to determine if interval change data corresponding to a change of the medical data over time is required;
extracting keywords from a predetermined field in the medical report corresponding to an interval change;
categorizing the extracted keywords into a first category corresponding to the interval change if the keywords conform to a first pattern and categorizing the extracted keywords into a second category if the keywords conform to a second pattern; and
generating a notification message if the keywords correspond to the second category.
